(19) United States
(12) Patent Application Publication
(10) Pub. No.: US 2009/0060063 A1
(43) Pub. Date: Mar. 5, 2009

(54) Method and Apparatus for Robust Control Signaling Distribution in OFDM Systems

(75) Inventor: Jiann-Ching Guey, Cary, NC (US)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 11/848,581

(22) Filed: Aug. 31, 2007

(51) Int. Cl. H04L 27/28

(52) U.S. Cl. 375/260

(57) ABSTRACT

Orthogonal Frequency Division Multiplex (OFDM) systems distribute some number of pilot subcarriers within the larger set of subcarriers comprising an OFDM signal. In that context, according to teachings presented herein, control signaling is sent on subcarriers selected for their proximity to pilot subcarriers. Correspondingly, an OFDM receiver is configured to receive an OFDM signal having a control signaling subcarrier positioned proximate in a frequency-time plane to a pilot subcarrier, and generate a scalar-valued channel estimate for demodulating symbols from the control signaling subcarrier based on observations limited to the proximate pilot subcarrier. Channel estimation with respect to the control signaling subcarriers thus is robust, yet simplified. The method may be applied to all control signaling, or selectively applied to higher-priority control signaling, such as paging.

### BACKGROUND

1. Technical Field

The present invention generally relates to OFDM communication systems, and particularly relates to robust control signaling in OFDM communication systems.

2. Background

In an Orthogonal Frequency Division Multiplexing (OFDM) system, known symbols referred to as pilots are transmitted across the time-frequency plane, and used by the receiving device to estimate the channel's time-frequency response for performing coherent demodulation of data symbols. Because the channel's time-frequency response is a slow-varying, two-dimensional process, the pilot symbols essentially sample this process and therefore need to have a density that is high enough for the receiving device to reconstruct (or interpolate) the full response of the channel.

Of course, the cost of increasing pilot density is the reduction in available bandwidth for information transmission. Consequently, common approaches to pilot transmission strike a balance between the number (and pattern) of transmitted pilots providing for good channel estimation performance at the receiver, and the desire to maximize the information-carrying capacity of the OFDM carrier. The receiver's task, then, is to generate channel estimates for non-pilot frequencies based on its observation of the channel at the pilot frequencies. Various interpolation and extrapolation approaches are used for extending the pilot-based channel estimates over the non-pilot subcarrier frequencies.

### SUMMARY

Orthogonal Frequency Division Multiplex (OFDM) systems distribute some number of pilot subcarriers within the larger set of subcarriers comprising an OFDM signal. In that context, according to teachings presented herein, control signaling is sent on subcarriers selected for their proximity to pilot subcarriers. A non-limiting advantage of using subcarriers that are close to pilot subcarriers for carrying control signaling is that doing so facilitates channel estimation for the control signaling subcarriers, and thereby improves demdodulation of the control signaling.

In one embodiment presented herein, a method of transmitting control signaling within an OFMD signal to facilitate channel estimation at a receiver with respect to the control signaling comprises selecting one or more subcarriers within the OFDM signal that are proximate in a frequency-time plane to one or more pilot subcarriers within the OFDM signal. The method further includes transmitting the control signaling on the one or more selected subcarriers.

“Proximate” as used herein relates to proximity in frequency and proximity in time. For example, a subcarrier in a frequency position one or two frequency steps away from a pilot subcarrier is proximate in frequency to that pilot subcarrier. Similarly, a subcarrier at the same frequency as a pilot subcarrier, but displaced earlier or later in time by one OFDM symbol period also is proximate to that pilot subcarrier. Thus, proximity connotes frequency proximity and/or time proximity in the frequency-time plane that defines the OFDM signal over successive OFDM symbol periods.

In another embodiment, a processing circuit for use in an OFDM transmitter comprises one or more processors that are configured to improve channel estimation at a receiver with respect to control signaling, based on selecting subcarriers for carrying control signaling that are proximate in a frequency-time plane to pilot subcarriers in the OFDM signal. As previously described, the selection of proximate subcarriers exploits frequency proximity and/or time proximity, with respect to the frequency-time plane.

In at least one embodiment taught herein, proximate subcarriers include “first-tier” subcarriers, which are those subcarriers that are immediately adjacent to a pilot subcarrier in either frequency or (symbol) time, and further include “second-tier” subcarriers. Second-tier subcarriers are those subcarriers that are one OFDM symbol time and one subcarrier frequency position away from a pilot subcarrier in the OFDM frequency-time plane. One or more embodiments preferentially use first-tier subcarriers. For example, control signaling may be sent on first-tier subcarriers, to the extent that there are a sufficient number of first-tier subcarriers for transmitting the control signaling.

In the same or other embodiments, some control signaling is deemed higher-priority than other control signaling. The higher-priority control signaling is sent on first-tier and/or second-tier subcarriers, and the other (lower-priority) control signaling is sent on one or more subcarriers further removed from the pilot subcarriers.

The above transmitter methods and apparatuses allow more robust yet simplified channel estimation at the receiver. In at least one embodiment presented herein, a method of channel estimation in a wireless communication receiver comprises receiving an OFDM signal having a control signaling subcarrier positioned proximate in a frequency-time plane to a pilot subcarrier, and generating a scalar-valued channel estimate for demodulating symbols from the control signaling subcarrier based on observations limited to the proximate pilot subcarrier. The scalar-valued computations are substantially simplified with little performance loss relative to the matrix/vector approach that would otherwise be needed for interpolating the OFDM channel between or across pilot subcarriers not necessarily proximate to the control signaling subcarriers.

Accordingly, one embodiment of a wireless communication receiver comprises a receiver circuit configured to receive an OFDM signal having a control signaling subcarrier positioned proximate in a frequency-time plane to a pilot subcarrier, and a channel estimation circuit configured to generate a scalar-valued channel estimate for demodulating symbols from the control signaling subcarrier based on observations limited to the proximate pilot subcarrier. For example, the channel estimation circuit may be configured to generate the scalar-valued channel estimate by generating a scalar-valued Minimum Mean Square Error (MMSE) channel estimate for the control signaling subcarrier based on the proximate pilot subcarrier. In that context, one or more embodiments of the receiver are configured to consider the channel correlation between the control signaling subcarrier and the proximate pilot subcarrier as part of the channel estimation. One or more other embodiments further simply the channel estimation for the control signaling subcarrier by assuming a one-to-one channel correlation.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of an OFDM transmitter and one embodiment of an OFDM-based wireless communication device.

FIG. 2 is a block diagram of circuit details in one embodiment of an OFDM transmitter, where one or more processing circuits are configured to select subcarriers proximate to pilot subcarriers for the transmission of control signaling.

FIG. 3 is a logic flow diagram of a method of selecting subcarriers proximate to pilot subcarriers for the transmission of control signaling.

FIG. 4 is a diagram of an example set of subcarriers in an OFDM signal, including pilot subcarriers and proximate subcarriers, shown over multiple symbol times.

FIG. 5 is a graph comparing channel estimation error as a function of time and frequency distance away from pilot subcarriers, for pilot information at and below the Nyquist rate of the OFDM channel.

FIG. 6 is a block diagram of one embodiment of a receiver, such as can be implemented in the wireless communication device of FIG. 1, for robust, but simplified channel estimation for control signaling subcarriers that are proximate to pilot subcarriers in a received OFDM signal.

FIG. 7 is a logic flow diagram of one embodiment of a method of robust, but simplified channel estimation for control signaling subcarriers that are proximate to pilot subcarriers in a received OFDM signal.

FIG. 8 is a graph illustrating example Frame Error Rates performance yielded by the robust, but simplified channel estimation as outlined in FIG. 7.

### DETAILED DESCRIPTION

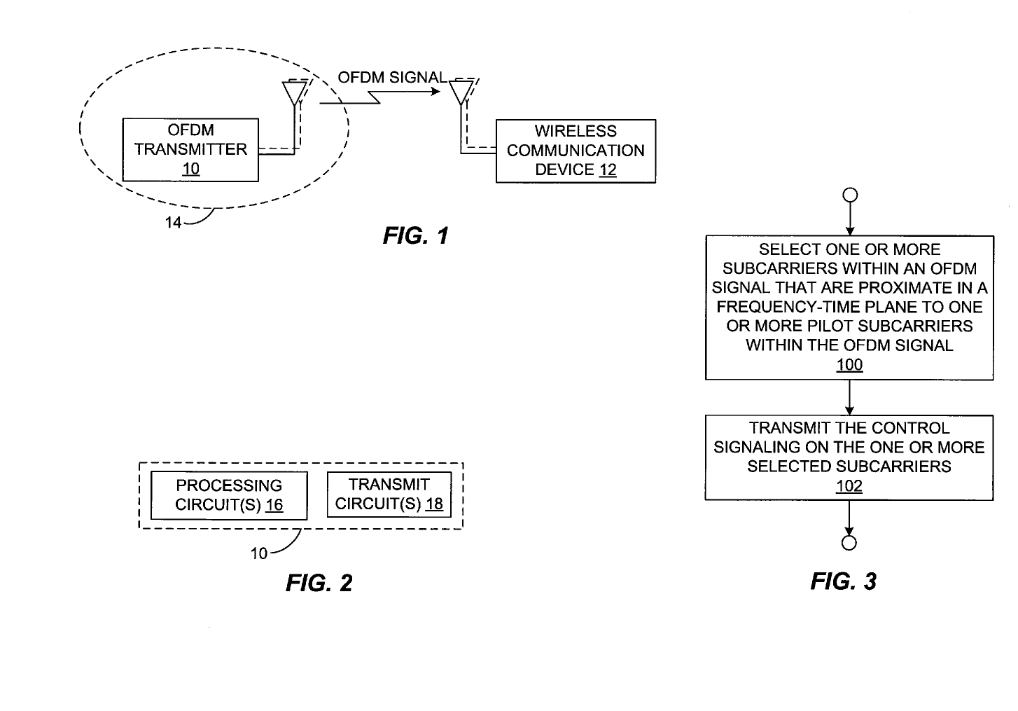

FIG. 1 illustrates one embodiment of a transmitter 10 that is configured to transmit an Orthogonal Frequency Division Multiplex (OFDM) signal to one or more receiving devices, although only one wireless communication device 12 is illustrated for simplicity. As will be detailed later herein, the transmitter 10 selects one or more subcarriers in the OFDM signal that are proximate to pilot subcarriers, and uses those selected subcarriers for the transmission of control signaling. This method of control signaling subcarrier transmission, which in one or more embodiments, comprises clustering control signaling subcarriers around pilot subcarriers, facilitates channel estimation at the wireless communication device 12.

More particularly, selecting subcarriers for control signaling that are proximate to pilot subcarriers facilitates channel estimation at the wireless communication device 12 with respect to the control signaling. More particularly, the wireless communication device 12 is configured to implement a robust yet computationally simplified channel estimation process for the control signaling subcarriers based on their proximity to pilot subcarriers.

As non-limiting examples, the transmitter 10 comprises a radio base station in a wireless communication network 14. In at least one such embodiment, the transmitter 10 comprises a base station configured according to the Long Term Evolution (LTE) extensions of the Wideband Code Division Multiple Access (WCDMA) standards promulgated by the Third Generation Partnership Project (3GPP). Correspondingly, the wireless communication device 12 comprises a compatible cellular radiotelephone, PDA, pager, radio modem card, or other mobile station or communications device.

Regardless of their particular implementation details, FIG. 2 illustrates one embodiment of functional circuits for the transmitter 10, which include one or more processing circuits 16 and operatively associated transmit circuit 18. Broadly, the transmit circuits 18, which may operate partially or fully under control by the processing circuit(s) 16, transmit one or more OFDM signals, each comprising a plurality of subcarriers, with selected ones of those subcarriers serving as pilots. In turn, the processing circuit(s) 16 select one or more subcarriers that are proximate to one or more pilot subcarriers, for use in transmitting control signaling.

In more detail, in at least one embodiment, the processing circuit(s) 16 are configured to perform the processing actions illustrated in FIG. 3. Those skilled in the art should appreciate that the one or more processing circuits 16 comprise hardware, software, or any combination thereof. For example, the processing circuits 16 comprise one or more general- or special-purpose microprocessors or digital signal processors that execute computer program instructions stored in a computer-readable medium, where those instructions implement the processing actions of FIG. 3, or variations thereof.

Those skilled in the art should further appreciate that the processing actions illustrated in FIG. 3 may represent ongoing processing, which itself may be carried out along with, or as part of a larger set of processing activities at the transmitter 10. For example, the control signaling related actions illustrated in FIG. 3 may be carried out in coordination with any number of ongoing OFDM transmission processing activities.

With the above understanding in mind, the method embodiment illustrated in FIG. 3 “begins” with selecting one or more sub-carriers within an OFDM signal that are proximate in a frequency-time plane to one or more pilot subcarriers within the OFDM signal (Block 100). Processing continues with transmitting the control signaling on the one or more selected subcarriers (Block 102).

It should be noted that one embodiment contemplated herein sends control signaling on subcarriers proximate to common pilot subcarriers in the OFDM signal. Of course, it is also contemplated that control signaling reception may be improved by transmitting control signaling on subcarriers proximate to dedicated pilots, which may be specific to individual receivers, such as the wireless communication device 12 depicted in FIG. 1, or to groups of receivers. Thus, an embodiment of the control signaling method presented herein comprises selecting one or more subcarriers that are proximate to one or more common or dedicated pilot subcarriers, for use in transmitting control signaling.

Of course, it also should be understood that not all control signaling transmitted by the transmitter 10 necessarily is sent on the selected subcarriers. For example, the one or more processing circuits 16 depicted in FIG. 2 for the transmitter 10 may be configured to send higher-priority, e.g., more critical, control signaling on one or more subcarriers selected for their proximity to pilot subcarriers in the (OFDM) frequency-time plane. At the same time, or at different times, lower-priority control signaling may be sent on subcarriers that are not proximate to any pilot subcarriers. As a non-limiting example, paging control signaling is considered as higher-priority control signaling and the method thus may comprise transmitting at least the paging control signaling on the one or more selected subcarriers.

In some types of systems, it may be particularly advantageous to send paging control signaling on OFDM subcarriers that are proximate to OFDM pilot subcarriers in the OFDM frequency-time plane. Of course, in such systems, and in general, it should be understood that the method of transmitting control signaling presented herein contemplates reselecting subcarriers to carry the control signaling as needed, responsive to changing designations of pilot subcarriers within the OFDM signal. That is, to the extent the particular subcarriers used as pilot signals changes over OFDM symbol times, so too will the selection of proximate subcarriers for carrying the control signaling.

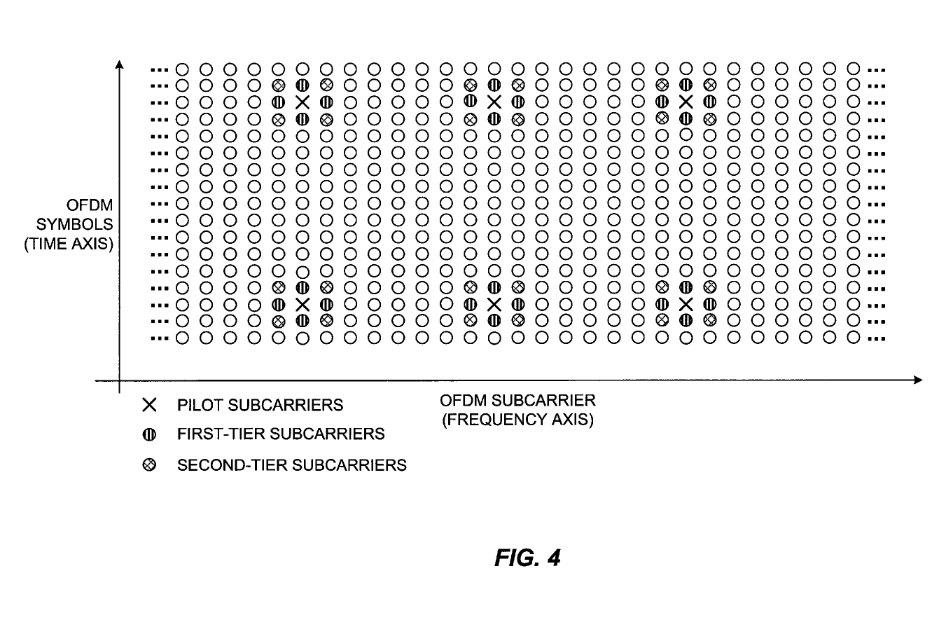

FIG. 4 provides a non-limiting example of subcarrier selection for the transmission of control signaling, and visually depicts the OFDM frequency-time plane in which “proximity” is evaluated. In the diagram, each column represents a different subcarrier frequency defined within the OFDM signal, and each row represents a different OFDM symbol time. (OFDM “symbol times” are, in one or more embodiments, the set of all subcarriers in an OFDM signal taken over regularly repeating transmission intervals.)

While the frequency axis and time axis depicted in FIG. 4 define one example frequency-time plane, FIG. 4 should be understood as descriptive, and is not meant to depict a limiting OFDM signal structure in terms of the number of subcarriers, the placement and repetition of pilot subcarriers, etc. However, FIG. 4 does illustrate one approach for selecting control signaling subcarriers based on their proximity to pilot subcarriers in the frequency-time plane.

More particularly, for the illustrated pilot subcarriers, FIG. 4 depicts two classes of proximate subcarriers for possible selection in control signaling transmission. “First tier” subcarriers are those subcarriers within the OFDM signal that are immediately adjacent to pilot subcarriers in the frequency-time plane. In this context, “immediately adjacent” is defined as being next to a pilot subcarrier in frequency position (within the same symbol time), or at the same frequency position as a pilot subcarrier, but in the immediately prior or immediately successive OFDM symbol times. In other words, the first-tier subcarriers that are candidates for carrying control signaling are those subcarriers immediately next to a pilot subcarrier, in either time or frequency.

FIG. 4 also identifies a second class of proximate subcarriers, which are referred to as “second-tier” subcarriers. More particularly, the four first-tier positions are the subcarrier locations that are either one OFDM symbol time or one subcarrier away from a pilot subcarrier, and the four second-tier positions are the subcarrier locations that are one symbol time and one subcarrier away from the pilot. In total, there are eight adjacent, first-tier and second-tier positions around each pilot symbol available for assignment.

With FIG. 4 in mind, then, one embodiment of selecting one or more subcarriers within an OFDM signal that are proximate in the frequency-time plane to one or more pilot subcarriers comprises selecting one or more first-tier subcarriers. In other embodiments, the method comprises selecting at least one of a first-tier subcarrier and a second-tier subcarrier.

Of course, given that first-tier subcarriers are closer to pilot subcarriers than are second-tier subcarriers, the transmitter 10 can be configured to select first-tier subcarriers for the transmission of at least some control signaling, in preference over second-tier subcarriers. For example, the selection method may comprise selecting first-tier subcarriers in preference to second-tier subcarriers, such that the control signaling is transmitted on first-tier subcarriers to the extent there are enough first-tier subcarriers available for transmitting the control signaling.

Subcarrier selection preferences may be driven by control signaling priorities. For example, the control signaling may comprise first control signaling that is deemed higher in priority than second control signaling. One or more embodiments of the subcarrier selection method thus comprise sending the first control signaling on first-tier or second-tier subcarriers, and sending the second control signaling on one or more other subcarriers that are beyond the first-tier and second-tier subcarriers in the frequency-time plane. In another embodiment dealing with different types of control signaling, a first type of control signaling is sent on first-tier subcarriers or second-tier subcarriers, while a second type of control signaling is sent on subcarriers beyond the first- and second-tier subcarriers. The types may comprise different priority designations, and/or common-versus-dedicated control signaling types. In a refinement of this approach, the highest-priority control signaling is sent on first-tier subcarriers, and lower-priority control signaling is sent on second-tier or even further-removed subcarriers.

In another embodiment, the placement of control signaling subcarriers with respect to a given pilot subcarrier position preferably starts with the first tier of four adjacent subcarrier locations that are either one subcarrier frequency position or one OFDM symbol time away from the pilot subcarrier. If needed or desired, control signaling subcarrier placement continues to the second-tier of four subcarrier locations. Together, the first-tier and second-tier locations around a given pilot subcarrier provide up to eight proximate subcarrier positions for control signaling subcarriers. Of course, additional tiers may be added if necessary. However, in LTE systems, for example, pilot density typically exceeds one-percent and use of first- and second-tier locations provide for greater than eight percent control signaling overhead, which is sufficient in many applications.

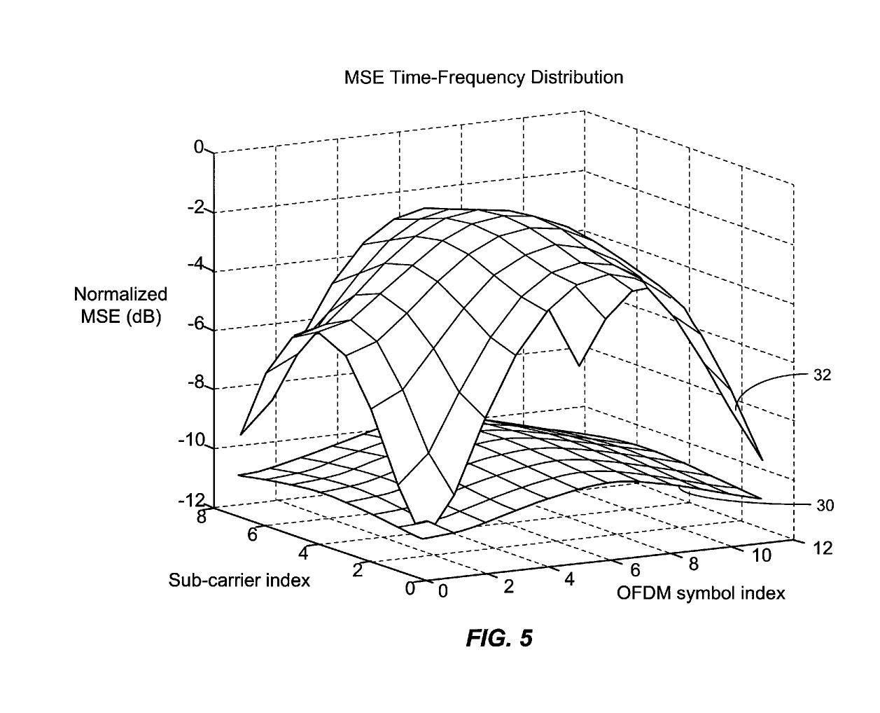

Regardless of the particular variation adopted for placing control signaling subcarriers, the selection of subcarriers proximate to pilot subcarriers for use in transmitting control signaling improves receiver channel estimation with respect to the control signaling subcarriers. To appreciate this improvement, FIG. 5 illustrates two channel estimation error surfaces 30 and 32, each representing the Mean Square Error (MSE) of channel estimation as a function of frequency-time plane distance from pilot subcarrier positions.

In the diagram, pilot subcarriers are at each corner of each error surface, and one sees that the maximum error occurs at the subcarrier position furthermost from the pilot subcarrier positions. However, the error surface 30 illustrates that even the maximum error for the illustrated set of pilot and non-pilot subcarriers is relatively low if the pilot subcarriers are provided at the Nyquist rate of the channel—e.g., at a sufficiently high pilot density for the given channel conditions. Conversely, the error surface 32 illustrates channel estimation error for a sub-Nyquist pilot rate of 1:1.25. The maximum MSE of the error surface 32 is much larger than that of the error surface 30.

FIG. 5 thus suggests that good channel estimation performance exists relatively close to pilot subcarriers, even during poor channel conditions. Put another way, the teachings herein ensure good channel estimation performance at receivers with respect to control signaling, even under poor channel conditions. This performance improvement is obtained not by increasing pilot density (although that also may be done if desired), but rather by placing the control signaling subcarriers close to the pilot subcarriers.

In more detail, at a given receiver (e.g., the wireless communication device 12), samples of the received OFDM signal may be represented in the discrete frequency domain as,

X[t,f]=H[t,f]Λ[t,f]+Z[t,f] Eq. (1)

where the index [t, f] corresponds to the fth sub-carrier in the tth OFDM symbol, H[t, f] is the channel's time-frequency response at that point, Λ[t, f] is the transmitted symbol and Z[t, f] is the Additive White Gaussian Noise (AWGN).

One may arrange the samples represented in Eq. (1) that correspond to the pilot subcarrier samples (referred to as pilot symbols), and express the pilot observations in a concise matrix form:

X_{c}=Λ_{c}H_{c}+Z_{c} Eq. (2)

wherein Λ_{c} is a diagonal matrix containing the (known) pilot symbols as its diagonal elements, and where X_{c}, H_{c}, and Z_{c} are column vectors of the same dimension corresponding to the actual observations of the received pilot symbols, the channel estimates, and the noise, respectively. Assuming N pilot symbols, Λ_{c} is an N×N matrix, and the three vectors are of dimension N×1.

It is known to model the channel H[t, f] at a given time/frequency position within the OFDM signal as a two-dimensional zero-mean Wide Sense Stationary (WSS) Gaussian random process. The channel correlation with respect to another time/frequency position is defined as,

Γ[t₁−t₂,f₁−f₂]≡E{H[t₁,f₁]H*[t₂,f₂]} Eq. (3)

With the matrix representation given in Eq. (2) and with knowledge of the channel's statistics, the Minimum Mean Square Error (MMSE) channel estimator is then given by,

Ĥ(X_{c})=E{H|X_{c}}=Π_{HX}_{_{c}}Π_{X}_{_{c}}⁻¹X_{c} Eq. (4)

Eq. (4) can be expressed as,

Ĥ(X_{c})=Π_{HH}_{_{c}}Λ_{c}^{H}(Λ_{c}Π_{H}_{_{c}}Λ_{c}^{H}+σ_{Z}²I)⁻¹X_{c} Eq. (5)

where Π_{H}_{_{c}}=E{H_{c}H_{c}^{H}}, which denotes the N×N auto covariance matrix of H_{c},
Π_{HH}_{_{c}}=E{HH_{c}^{H}}, which denotes the L×N covariance matrix between H and H_{c}, and
Π_{HX}_{_{c}} denotes the similarly dimensioned matrix between H and X_{c}.

Against the above equations, the positioning of control signaling subcarriers proximate to pilot subcarriers improves receiver channel estimation with respect to the control signaling by making channel estimation simpler (i.e., scalar-valued rather than matrix/vector based), and more robust (i.e., lower MSE by virtue of proximity to pilot subcarriers).

These advantages may be particularly beneficial in implementations where the control signaling is intended for multiple users, e.g., all receivers within a given cellular radio sector, and the channel conditions of different users may vary widely. In such cases, positioning common control signaling proximate to common pilots helps ensure that all intended receivers can perform accurate channel estimation with respect to the control signaling, without need for adding supplemental pilots to bolster channel estimation for users in particularly poor channel conditions.

Indeed, the control signaling transmission at the transmitter 10, and the corresponding channel estimation processing at the wireless communication device 12 (for that control signaling), and like channel estimation at any number of other receivers, can be designed for sufficient performance margins under worst-case scenarios. The worst-case scenario combines, for example, a minimum Signal-to-Noise Ratio (SNR) with a maximum channel delay-Doppler spread.

It is recognized herein that under such conditions there generally is no meaningful correlation between the channel at a given control signaling subcarrier and any channel other than that of the closest pilot subcarrier. Further, it is recognized herein that the transmitter 10 can ensure the strongest possible channel correlation between a given control signaling subcarrier and a given pilot subcarrier even under worst-case channel conditions, by placing the control signaling subcarrier proximate to the pilot subcarrier.

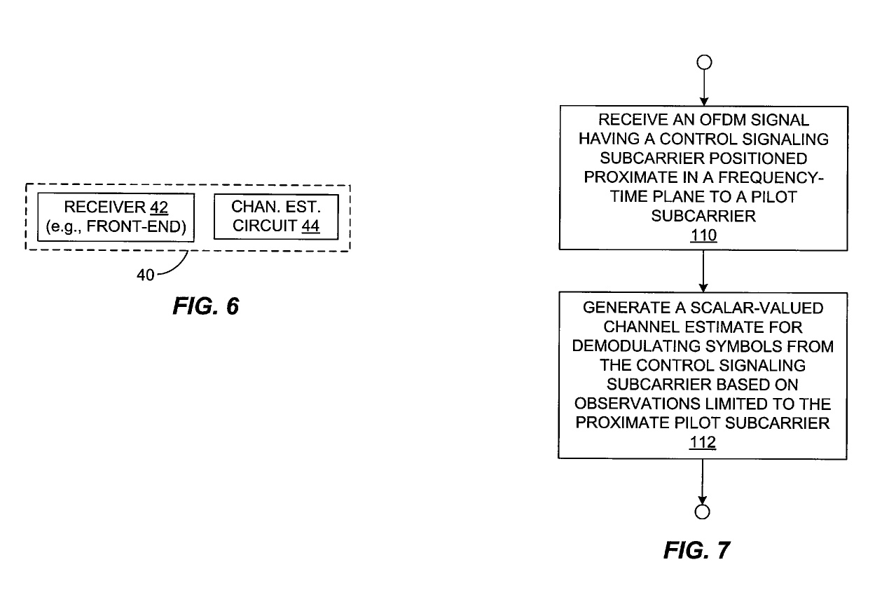

With that proximate positioning, channel estimation at the receiver can be based on a simplified MMSE estimator, which uses only the closet pilot for its estimation of the channel at a given control signaling subcarrier. FIG. 6 illustrates one embodiment of a wireless communication receiver 40. The receiver 40 is implemented in the wireless communication device 12, for example, and incorporates improved channel estimation as taught herein for control signaling subcarriers that are positioned within an OFDM signal proximate to pilot subcarriers.

The illustrated receiver 40 comprises a receiver circuit 42 (e.g., a receiver front-end circuit) and a channel estimation circuit 44. Those skilled in the art will appreciate that the receiver 40 may include other functional elements associated with received signal processing, and that the illustrated circuits may be implemented in hardware, software, or any combination thereof. For example, the receiver circuit 42 may include analog front-end circuits, such as filtering, amplification/gain-control, and analog-to-digital conversion circuits, which are configured to provide digital sample streams corresponding to the antenna-received OFDM signal(s).

In turn, the channel estimation circuit 44 may comprise part of a baseband processing circuit, which comprises one or more general- or special-purpose microprocessors configured via program instructions to carry out a number of digital signal processing functions, including channel estimation. Of course, other implementations are contemplated herein.

Regardless of the particular implementation details of the receiver 40, FIG. 7 illustrates one embodiment of a method of receiver processing implemented by the receiver 40 of the wireless communication device 12. The illustrated processing, which may comprise a portion of a larger set of receiver processing functions, “begins” with receiving an OFDM signal having a control signaling subcarrier positioned proximate in a frequency-time plane to a pilot subcarrier (Block 110). The receiver circuit 42 is, in one or more embodiments, configured to carry out this function and it includes at least front-end circuitry for obtaining digital sample streams from the antenna-received OFDM signal, and may include additional processing elements.

Processing continues with generating a scalar-valued channel estimate for demodulating symbols from the control signaling subcarrier based on observations limited to the proximate pilot subcarrier (Block 112). Limiting the pilot observations to the proximate pilot subcarrier means that the channel estimation process uses scalar values, rather than matrix/vector values as conventionally occurs when multiple pilots are considered in an interpolative channel estimation process. See, e.g., Eq. (4) and Eq. (5).

The channel estimation circuit 44 is, in one or more embodiments, configured to carry out the processing of Block 110. That is, the channel estimation circuit 44 is configured to generate a scalar-valued channel estimate for demodulating symbols from the control signaling subcarrier based on observations limited to the proximate pilot subcarrier. The scalar-valued channel estimate represents a computationally-simplified yet robust method of channel estimation, which exploits the fact that the channel for a given control signaling subcarrier can be accurately estimated using pilot observations limited to the closest pilot subcarrier, assuming, of course, that the closest pilot subcarrier is close enough, e.g., the controlling signaling subcarrier occupies a first-tier or second-tier position relative to the pilot subcarrier.

In at least one embodiment, the channel estimation circuit 44 is configured to generate the scalar-valued channel estimate by generating a scalar-valued Minimum Mean Square Error (MMSE) channel estimate for a given control signaling subcarrier based on the proximate pilot subcarrier. In such processing, the channel estimation circuit 44 determines the scalar-valued channel estimate as a function of scalar values corresponding to known pilot symbol values, pilot symbol observations made at the receiver 40 for the proximate pilot subcarrier, and a correlation value representing the channel correlations between the control signaling subcarrier and the proximate pilot subcarrier.

For example, the channel estimation circuit 44 may be configured to determine the scalar-valued channel estimate Ĥ(X_{C}) for a given control signaling subcarrier as

$$\begin{matrix}\hat{H} ( {X}_{C} ) = E \{ H \vert {X}_{C} \} \\ = {Π}_{{HX}_{C}} {Π}_{{X}_{C}}^{- 1} {X}_{C} \\ = \frac{{Π}_{{HH}_{C}} {λ}_{C}^{H} {X}_{C}}{{\vert {λ}_{C} \vert}^{2} + {σ}_{Z}^{2}}\end{matrix} \qquad Eq . ( 6 )$$

where λ_{C}, X_{C}, and Π_{HH}_{_{C}} are scalars corresponding to the pilot symbol value, the pilot observation, and the correlation between the channel response at the control signaling subcarrier location (in the OFDM frequency-time plane) and the channel response at the observation location, i.e., at the pilot subcarrier position in the OFDM frequency-time plane).

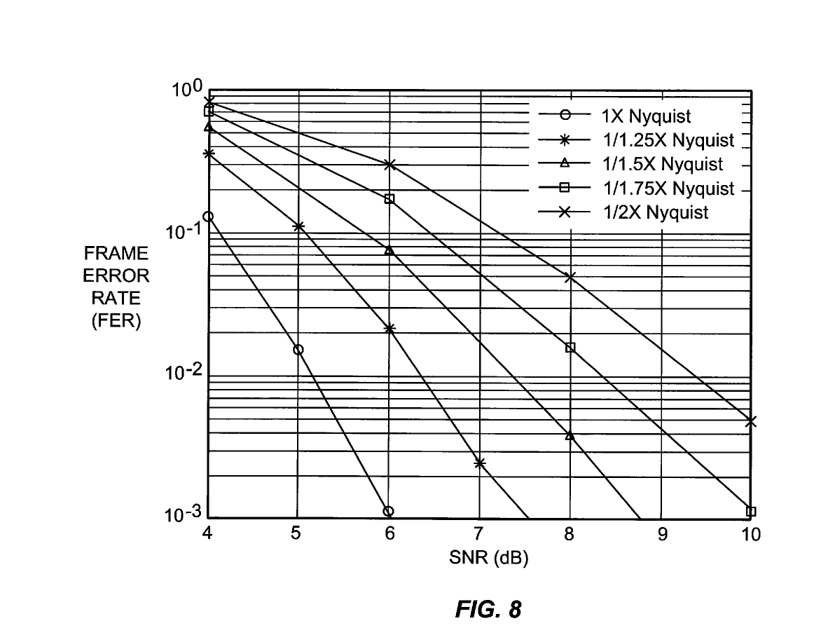

FIG. 8 illustrates channel estimation performance for a 3GPP LTE embodiment of the wireless communication device 12, where the channel estimation circuit 44 is configured to perform channel estimation for a given control signaling subcarrier using the scalar-valued processing of Eq. (6), based on the first-tier proximity shown in FIG. 4. The performance plot further assumes the following simulation parameters: Discrete Fourier Transform (DFT) length=256; Cyclic Prefix Length (at the transmitter 10)=32; number of OFDM symbols transmitted per pilot period=12; number of subcarriers per pilot period=8; number of information bits=256; Turbo Code Rate=one-half (½); transmit modulation format=Quadrature Phase Shift Keying (QPSK); channel estimation type at the wireless communication device=MMSE; and channel model=exponential×Bessel function.

One sees that the Frame Error Rate (FER) depicted in FIG. 8 is acceptable, even when the pilot density is at one-half the channel's maximal delay-Doppler spread. A further advantage of the proposed control signaling subcarrier mapping is increased diversity gain resulting from the spreading of the control signaling symbols across the OFDM frequency band (assuming that pilot subcarriers are spread across the band, and that control signaling subcarriers are distributed around different ones of those pilots).

In a related embodiment, but one that offers additional computational simplifications, the channel estimation circuit 44 determines the scalar-valued channel estimate as a function of scalar values corresponding to known pilot symbol values and pilot symbol observations made at the receiver for the proximate pilot subcarrier, but simplifies that determination by assuming a one-to-one correlation between the control signaling subcarrier and the proximate pilot subcarrier. That is, as the control signaling subcarrier and the pilot subcarrier are adjacent (e.g., either first-tier or second-tier proximity), one may assume that the correlation between the control signaling subcarrier channel H and the pilot subcarrier channel H_{c} is one (i.e., Π_{HH}_{_{c}}=Π_{H}_{_{c}}_{H}_{_{c}}=1. (Note that some embodiments use this simplifying correlation assumption if the control signaling subcarrier of interest occupies a first-tier position but not if it occupies a second-tier position.)

Of course, those skilled in the art will appreciate that multiple variations on scalar-valued channel estimation may be practiced in an appropriately configured receiver, in a manner complementary with varying or multiple control signaling transmission configurations. Broadly, the teachings herein provide methods and apparatuses that ensure the reception of control signaling in an OFDM signal even when the receiving device operates in channel conditions that are worse than the OFDM signal pilot density was intended to support.

That reception capability is provided by the selection of subcarriers that are proximate to pilot subcarriers in frequency/time within the OFDM signal, for use in transmitting control signaling. Because of the proximity, the receiver's estimation of channel conditions for a given control signaling subcarrier can be limited to scalar-valued quantities, including pilot observations limited to the proximate pilot subcarrier. That limitation avoids, at least for the control signaling subcarrier, interpolating channel conditions over observations of multiple pilots. As an added benefit, the robust channel estimation performance enables less pilot symbol overhead, because extra pilots generally are not needed to ensure good control signaling reception, even for receiving devices experiencing poor channel conditions.

With these and other advantages in mind, those skilled in the art will appreciate that the foregoing description and the accompanying drawings represent non-limiting examples of the methods and apparatuses taught herein. As such, the present invention is not limited by the foregoing description and accompanying drawings. Instead, the present invention is limited only by the following claims and their legal equivalents.

What is claimed is:

1. A method of transmitting control signaling within an Orthogonal Frequency Division Multiplex (OFMD) signal to facilitate channel estimation at a receiver with respect to the control signaling, the method comprising:
selecting one or more subcarriers within the OFDM signal that are proximate in a frequency-time plane to one or more pilot subcarriers within the OFDM signal; and
transmitting the control signaling on the one or more selected subcarriers.

2. The method of claim 1, wherein selecting one or more subcarriers within the OFDM signal that are proximate in a frequency-time plane to one or more pilot subcarriers within the OFDM signal comprises selecting one or more first-tier subcarriers, where first-tier subcarriers are those subcarriers that are immediately adjacent to pilot subcarriers in the frequency-time plane.

3. The method of claim 1, wherein selecting one or more subcarriers within the OFDM signal that are proximate in a frequency-time plane to one or more pilot subcarriers within the OFDM signal comprises selecting at least one of a first-tier subcarrier and a second-tier subcarrier, where first-tier subcarriers are those subcarriers immediately adjacent to pilot subcarriers in the frequency-time plane and second-tier subcarriers are those subcarriers one OFDM symbol time and one subcarrier frequency position away from a pilot subcarrier in the OFDM frequency-time plane.

4. The method of claim 3, further comprising selecting first-tier subcarriers in preference to second-tier subcarriers, such that the control signaling is transmitted on first-tier subcarriers to the extent there are enough first-tier subcarriers available for transmitting the control signaling.

5. The method of claim 3, wherein the control signaling comprises first control signaling that is deemed higher in priority than second control signaling, and further comprising sending the first control signaling on first-tier or second-tier subcarriers, and sending the second control signaling on one or more other subcarriers that are beyond the first-tier and second-tier subcarriers in the frequency-time plane.

6. The method of claim 1, wherein transmitting the control signaling on the one or more selected subcarriers comprises transmitting at least paging control signaling on the one or more selected subcarriers.

7. The method of claim 1, further comprising reselecting subcarriers to carry the control signaling as needed, responsive to changing designations of pilot subcarriers within the OFDM signal.

8. The method of claim 1, wherein selecting one or more subcarriers within the OFDM signal that are proximate in a frequency-time plane to one or more pilot subcarriers within the OFDM signal comprises selecting one or more subcarriers that are proximate to one or more common or dedicated pilot subcarriers.

9. A processing circuit for use in an Orthogonal Frequency Division Multiplex (OFDM) transmitter, said processing circuit comprising one or more processors configured to improve channel estimation at a receiver with respect to control signaling by selecting subcarriers for carrying control signaling that are proximate in a frequency-time plane to pilot subcarriers in the OFDM signal.

10. The processing circuit of claim 9, wherein the processing circuit is configured to select subcarriers for carrying the control signaling as one or more first-tier subcarriers, where first-tier subcarriers are those subcarriers that are immediately adjacent to pilot subcarriers in the frequency-time plane.

11. The processing circuit of claim 9, wherein the processing circuit is configured to select subcarriers for carrying the control signaling as first-tier or second-tier subcarriers, where first-tier subcarriers are those subcarriers immediately adjacent to pilot subcarriers in the frequency-time plane and second-tier subcarriers are those subcarriers one OFDM symbol time and one subcarrier frequency position away from a pilot subcarrier in the OFDM frequency-time plane.

12. The processing circuit of claim 11, wherein the processing circuit is configured to select first-tier subcarriers in preference to second-tier subcarriers, such that the control signaling is transmitted on first-tier subcarriers to the extent there are enough first-tier subcarriers available for transmitting the control signaling.

13. The processing circuit of claim 11, wherein the control signaling comprises first control signaling that is deemed higher in priority than second control signaling, and wherein the processing circuit is configured to send the first control signaling on first-tier or second-tier subcarriers and send the second control signaling on one or more other subcarriers that are beyond the first-tier and second-tier subcarriers in the frequency-time plane.

14. The processing circuit of claim 9, wherein the processing circuit is configured to transmit at least paging control signaling on the one or more selected subcarriers.

15. The processing circuit of claim 9, wherein the processing circuit is further configured to reselect subcarriers for carrying the control signaling as needed across OFDM symbol times, responsive to changing designations of pilot subcarriers within the OFDM signal.

16. The processing circuit of claim 9, wherein the processing circuit is configured to select subcarriers for carrying the control signaling by selecting one or more subcarriers that are proximate in the frequency-time plane to one or more common or dedicated pilot subcarriers.

17. In a wireless communication receiver, a method of channel estimation comprising:
receiving an OFDM signal having a control signaling subcarrier positioned proximate in a frequency-time plane to a pilot subcarrier; and
generating a scalar-valued channel estimate for demodulating symbols from the control signaling subcarrier based on observations limited to the proximate pilot subcarrier.

18. The method of claim 17, wherein generating a scalar-valued channel estimate for demodulating symbols from the control signaling subcarrier based on observations limited to the proximate pilot subcarrier comprises generating a scalar-valued Minimum Mean Square Error (MMSE) channel estimate for the control signaling subcarrier based on the proximate pilot subcarrier.

19. The method of claim 17, wherein generating a scalar-valued channel estimate for demodulating symbols from the control signaling subcarrier based on observations limited to the proximate pilot subcarrier comprises determining the scalar-valued channel estimate as a function of scalar values corresponding to known pilot symbol values, pilot symbol observations made at the receiver for the proximate pilot subcarrier, and a correlation value representing the channel correlations between the control signaling subcarrier and the proximate pilot subcarrier.

20. The method of claim 17, wherein generating a scalar-valued channel estimate for demodulating symbols from the control signaling subcarrier based on observations limited to the proximate pilot subcarrier comprises determining the scalar-valued channel estimate as a function of scalar values corresponding to known pilot symbol values and pilot symbol observations made at the receiver for the proximate pilot subcarrier, and assuming a one-to-one channel correlation between the control signaling subcarrier and the proximate pilot subcarrier.

21. A wireless communication receiver comprising:
a receiver circuit configured to receive an OFDM signal having a control signaling subcarrier positioned proximate in a frequency-time plane to a pilot subcarrier; and
a channel estimation circuit configured to generate a scalar-valued channel estimate for demodulating symbols from the control signaling subcarrier based on observations limited to the proximate pilot subcarrier.

22. The wireless communication receiver of claim 21, wherein the channel estimation circuit is configured to generate the scalar-valued channel estimate by generating a scalar-valued Minimum Mean Square Error (MMSE) channel estimate for the control signaling subcarrier based on the proximate pilot subcarrier.

23. The wireless communication receiver circuit of claim 21, wherein the channel estimation circuit is configured to generate the scalar-valued channel estimate by determining the scalar-valued channel estimate as a function of scalar values corresponding to known pilot symbol values, pilot symbol observations made at the receiver for the proximate pilot subcarrier, and a correlation value representing the channel correlations between the control signaling subcarrier and the proximate pilot subcarrier.

24. The wireless communication receiver circuit of claim 21, wherein the channel estimation circuit is configured to generate the scalar-valued channel estimate by determining the scalar-valued channel estimate as a function of scalar values corresponding to known pilot symbol values and pilot symbol observations made at the receiver for the proximate pilot subcarrier, and assuming a one-to-one correlation between the control signaling subcarrier and the proximate pilot subcarrier.

25. A method of transmitting control signaling within an Orthogonal Frequency Division Multiplex (OFMD) signal to facilitate channel estimation at a receiver with respect to the control signaling, the method comprising clustering control signaling subcarriers around pilot subcarriers.
